(19) United States
(12) Patent Application Publication
(10) Pub. No.: US 2019/0201295 A1
(43) Pub. Date: Jul. 4, 2019

(54) Molar Toy and Method of Making The Same

(71) Applicant: Guang-Cheng Zhang, Wugang (CN)

(72) Inventor: Guang-Cheng Zhang, Wugang (CN)

(21) Appl. No.: 15/860,769

(22) Filed: Jan. 3, 2018

(51) Int. Cl. A61J 17/02; B29C 39/02; B29C 39/38

(52) U.S. Cl. CPC A61J 17/02; B29C 39/02; B29L 2031/529; B29K 2909/00; B29C 39/38

(57) ABSTRACT

A A molar toy contains: a body and an annular member. The body is made of flexible material and is formed in a capsule shape, and the body includes a hollow cavity defined therein, a first opening and a second opening which communicate with the hollow cavity and exterior environment. The annular member is inserted into the first opening and the second opening of the body so that a part of the annular member is accommodated in the hollow cavity of the body.

### FIELD OF THE INVENTION

The present invention relates to an infant product, and more particularly to a molar toy and a method of making the same.

### BACKGROUND OF THE INVENTION

A conventional molar toy is applied to be bit by infant, but is has following defects:

1. The molar toy is made of silicone or plastic and is connected by glue, thus reducing service life of the molar toy and damaging infant's heath.

2. A sounder is accommodated in the molar toy, and infant's saliva flows into the molar toy as biting the molar toy, thus growing bacterium in the molar toy easily.

The present invention has arisen to mitigate and/or obviate the afore-described disadvantages.

### SUMMARY OF THE INVENTION

The primary aspect of the present invention is to provide a molar toy which is directly washed by clean water, and water is poured out of the molar toy so as to maintain dry in the molar toy after washing the molar toy.

Another aspect of the present invention is to provide a molar toy in which all components are not connected by glue so as to obtain heath purpose.

To obtain above-mentioned aspects, a molar toy provided by the present invention contains: a body and an annular member.

The body is made of flexible material and is formed in a capsule shape, and the body includes a hollow cavity defined therein, a first opening and a second opening which communicate with the hollow cavity and exterior environment.

The annular member is inserted into the first opening and the second opening of the body so that a part of the annular member is accommodated in the hollow cavity of the body.

Preferably, the body includes a sounder arranged thereon.

Preferably, the annular member includes a first shoulder and a second shoulder arranged thereon, wherein the first shoulder contacts with the first opening, and the second shoulder contacts with the second opening.

Preferably, the annular member includes multiple bosses arranged on an outer wall thereof.

Preferably, the annular member includes multiple teeth grinding sheets one-piece formed on a peripheral side of the outer wall of the annular member.

Preferably, the body is made of emulsion.

Preferably, the annular member is fitted in the hollow cavity which has a channel communicating with the hollow cavity, wherein the channel extends along a length direction of the annular member.

In addition, a method of making the molar toy contains steps of:

providing a mold, wherein the mold is made of plaster so as to absorb water, and the mold is formed based on a shape of the molar toy;

pouring, wherein the annular member is accommodated in the mold, and the mold is locked and closed so as to pour emulsion into the mold, hence the emulsion is full of the mold, and the mold is stood so as to absorb water of the emulsion;

drying, wherein the emulsion is poured out of the mold, and the mold is placed into a baker so as to be baked until moisture content of the molar toy remains 20% to 25%; and

baking, wherein the mold is unlocked and opened so as to remove the molar toy from the mold, and the molar toy is placed into the baker for being baked for 15 hours to 24 hours, thereafter the molar toy is trimmed, deburred, colored so as to acquire a finished product.

Preferably, the mold is stood for 20 min to 25 after pouring the emulsion into the mold in the step of pouring min.

Preferably, a baking temperature of the baker is 70° C. to 80° C. in the step of baking, and a baking temperature of the baker is 70° C. to 80° C. in the step of drying.

### BRIEF DESCRIPTION OF THE DRAWINGS

FIG. 1 is a perspective view showing the assembly of a molar toy according to a first embodiment of the present invention.

FIG. 2 is a perspective view showing exploded components of the molar toy according to the first embodiment of the present invention.

### DETAILED DESCRIPTION OF THE PREFERRED EMBODIMENTS

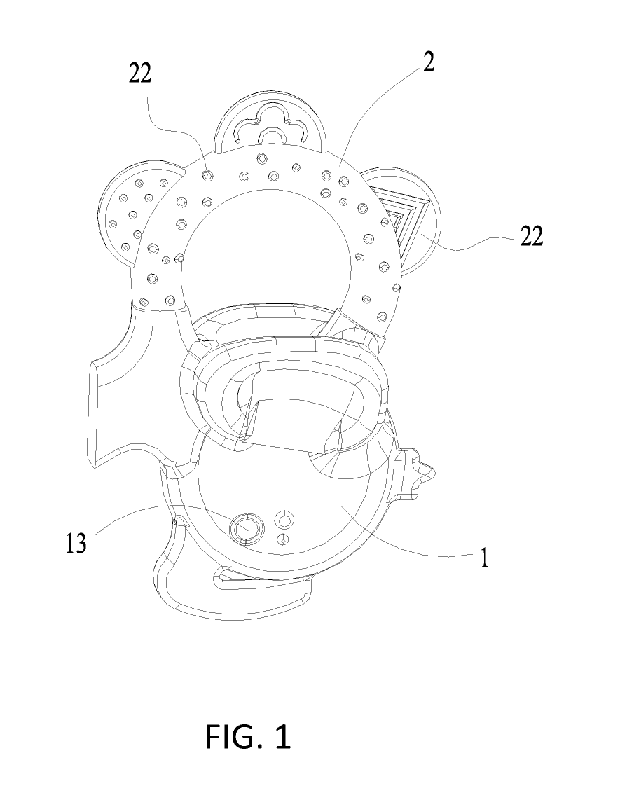

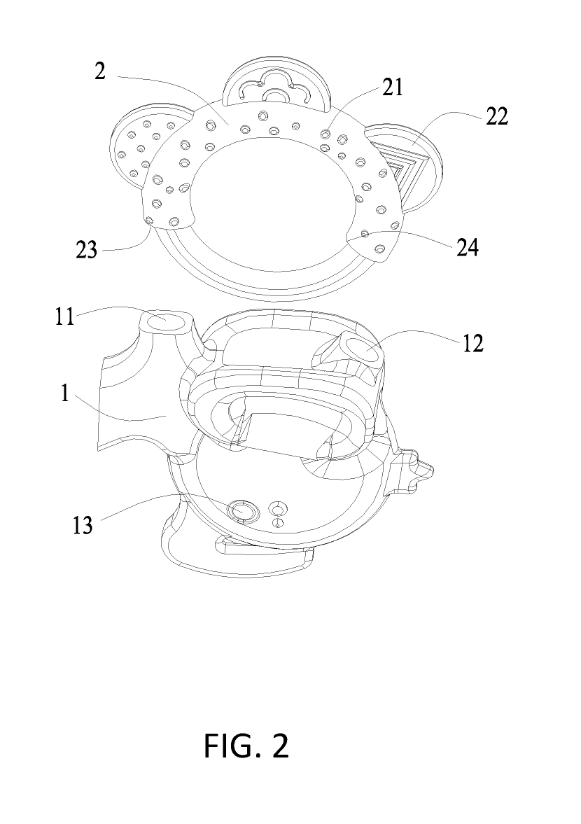

With reference to FIGS. 1 and 2, a molar toy according to a first embodiment of the present invention comprises: an annular member 2 and a body 1, wherein the body 1 is made of flexible material and is formed in a capsule shape, and the body 1 includes a hollow cavity defined therein, a first opening 11 and a second opening 12 which communicate with the hollow cavity. The annular member 2 is inserted into the first opening 11 and the second opening 12 of the body 1 so that a part of the annular member 2 is accommodated in the hollow cavity of the body 1 and exterior environment. The body 1 includes a sounder 13 arranged thereon so as to make sounds after pressing the body 1 to flow air out of the sounder 13 from the body 1. The annular member 2 includes a first shoulder 23 and a second shoulder 24 arranged thereon, wherein the first shoulder 23 contacts with the first opening 11, and the second shoulder 24 contacts with the second opening 12, such that the annular member 2 matingly contacts with the body 1 so as to avoid air leakage.

The annular member 2 includes multiple bosses 21 arranged on an outer wall thereof, and the annular member 2 includes multiple teeth grinding sheets 22 one-piece formed on a peripheral side of the outer wall of the annular member 2 so as to enhance molar effect. The multiple teeth grinding sheets 22 and the annular member 2 are one-piece formed so as to reinforce the multiple teeth grinding sheets 22.

The body 1 is made of emulsion so as to obtain natural non-toxic purpose and environmental protection. The annular member 2 is fitted in the hollow cavity which has a channel communicating with the hollow cavity, wherein the channel extends along a length direction of the annular member 2. When pulling the body 1 opposite to the annular member 2, the channel communicates with the hollow cavity and the exterior environment so that user pours water out of the hollow cavity.

After using the molar toy of the present invention, the molar toy is directly washed by clean water. Due to the body 1 of the molar toy accommodates the sounder, the water flows into the hollow cavity of the body 1 easily to cause mildews in the hollow cavity. Because the annular member 2 is inserted into the body 1 and the body 1 is flexible, the annular member 2 is pulled opposite to the body 1 so that slits form among the annular member 2, the first opening 11, and the second opening 12 respectively, thus pouring the water out of the body 1 so as to avoid mildews growing in the hollow cavity of the body 1.

With reference to FIGS. 1 and 2, a method of making the molar toy according to a second embodiment of the present invention comprises steps of:

providing a mold, wherein the mold is made of plaster and is formed based on a shape of the molar toy; and

pouring, wherein the annular member is accommodated in the mold, and the mold is locked and closed so as to pour emulsion into the mold, hence the emulsion is full of the mold, and the mold is stood for 15 min to 30 min. Preferably, the mold is stood for 22 min.

The method further comprises a step of drying, wherein the emulsion is poured out of the mold, and the mold is placed into a baker so as to be baked in a baking temperature of 60° C. to 80° C. until moisture content of the molar toy remains 20% to 30%. Preferably, the baking temperature of the baker is 70° C., and the moisture content of the molar toy remains 25%.

The method further comprises a step of baking, wherein the mold is unlocked and opened so as to remove the molar toy from the mold, and the molar toy is placed into the baker for being baked in a baking temperature of 70° C. to 80° C. for 15 hours to 24 hours, thereafter the molar toy is trimmed, deburred, colored so as to acquire a finished product. Preferably, the baking temperature of the baker is 75° C., and a baking time is 20 hours.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A molar toy comprising: a body and an annular member;
wherein the body is made of flexible material and is formed in a capsule shape, and the body includes a hollow cavity defined therein, a first opening and a second opening which communicate with the hollow cavity and exterior environment;
the annular member is inserted into the first opening and the second opening of the body so that a part of the annular member is accommodated in the hollow cavity of the body.

2. The molar toy as claimed in claim 1, wherein the body includes a sounder arranged thereon.

3. The molar toy as claimed in claim 1, wherein the annular member includes a first shoulder and a second shoulder arranged thereon, wherein the first shoulder contacts with the first opening, and the second shoulder contacts with the second opening.

4. The molar toy as claimed in claim 1, wherein the annular member includes multiple bosses arranged on an outer wall thereof.

5. The molar toy as claimed in claim 1, wherein the annular member includes multiple teeth grinding sheets one-piece formed on a peripheral side of the outer wall of the annular member.

6. The molar toy as claimed in claim 1, wherein the body is made of emulsion.

7. The molar toy as claimed in claim 1, wherein the annular member is fitted in the hollow cavity which has a channel communicating with the hollow cavity, wherein the channel extends along a length direction of the annular member.

8. A method of making the molar toy as claimed in claim 1 comprising steps of:
providing a mold, wherein the mold is made of plaster so as to absorb water, and the mold is formed based on a shape of the molar toy;
pouring, wherein the annular member is accommodated in the mold, and the mold is locked and closed so as to pour emulsion into the mold, hence the emulsion is full of the mold, and the mold is stood so as to absorb water of the emulsion;
drying, wherein the emulsion is poured out of the mold, and the mold is placed into a baker so as to be baked until moisture content of the molar toy remains 20% to 25%; and
baking, wherein the mold is unlocked and opened so as to remove the molar toy from the mold, and the molar toy is placed into the baker for being baked for 15 hours to 24 hours, thereafter the molar toy is trimmed, deburred, colored so as to acquire a finished product.

9. The method of making a molar toy as claimed in claim 8, wherein the mold is stood for 20 min to 25 after pouring the emulsion into the mold in the step of pouring min.

10. The method of making a molar toy as claimed in claim 8, wherein a baking temperature of the baker is 70° C. to 80° C. in the step of baking, and a baking temperature of the baker is 70° C. to 80° C. in the step of drying.
